(19) United States
(12) Patent Application Publication
(10) Pub. No.: US 2025/0233919 A1
(43) Pub. Date: Jul. 17, 2025

(54) SERVER, DEVICE, SYSTEM, AND METHOD

(71) Applicant: CANON KABUSHIKI KAISHA, Tokyo (JP)

(72) Inventor: SHOTA SHIMIZU, Kanagawa (JP)

(21) Appl. No.: 18/991,977

(22) Filed: Dec. 23, 2024

(30) Foreign Application Priority Data
Jan. 15, 2024 (JP) 2024-004117

(51) Int. Cl. H04L 67/141

(52) U.S. Cl. CPC H04L 67/141

(57) ABSTRACT

A device is configured to transmit, to a server, a connection request for establishing a connection between the device and the server, receive a service request to a server function of the device from the server through the connection, acquire a response generated by the server function to the service request, and transmit the response to the server. The server is configured to establish the connection in response to the connection request from the device, and transfer, to the device through the connection, the service request received from an information processing apparatus in a state in which the connection is established, and transfer, to the information processing apparatus, the response from the device to the service request.

### BACKGROUND OF THE INVENTION

### Field of the Invention

The present invention relates to a server, a device, a system, and a method.

### Description of the Related Art

A technology of constructing on-premises equivalent network environments on a cloud called a secure access service edge (SASE) has begun to be used in addition to known on-premises corporate network environments. An environment in which no corporate network exists is sometimes called a local area network (LAN)-less environment. Some devices such as multi-function peripherals have a server function. Japanese Patent Laid-Open No. 2009-151479 proposes a technique for safely using a server function of a device from a PC while remaining in a state of opening a server port of the device in a LAN-less environment. When the server port of the device is left open, the server port may be attacked.

### SUMMARY OF THE INVENTION

An aspect of the present invention provides a technology for enabling a server function of a device without using a server port of the device.

According to some embodiments, a system comprising a server and a device having a server function, wherein the device is configured to transmit, to the server, a connection request for establishing a connection between the device and the server, receive a service request to the server function from the server through the connection, acquire a response generated by the server function to the service request, and transmit the response to the server, and the server is configured to establish the connection in response to the connection request from the device, and transfer, to the device through the connection, the service request received from an information processing apparatus in a state in which the connection is established, and transfer, to the information processing apparatus, the response from the device to the service request is provided.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration example of a system according to a first embodiment.

FIG. 2 is a block diagram illustrating a software configuration example of the system according to the first embodiment.

FIGS. 3A to 3C are schematic diagrams illustrating an example of a screen displayed in the system according to the first embodiment.

FIG. 4 is a sequence diagram illustrating an operation example of the first embodiment.

FIGS. 5A and 5B are flow diagrams showing an operation example of the first embodiment.

FIGS. 6A and 6B are flow diagrams showing an operation example of the first embodiment.

FIGS. 7A to 7C are flow diagrams showing an operation example of the first embodiment.

FIG. 8 is a block diagram illustrating a hardware configuration example of a system according to a second embodiment.

FIGS. 9A and 9B are schematic diagrams illustrating an example of a screen displayed in the system according to the second embodiment.

FIG. 10 is a sequence diagram illustrating an operation example of the second embodiment.

FIG. 11 is a flowchart showing an operation example of the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

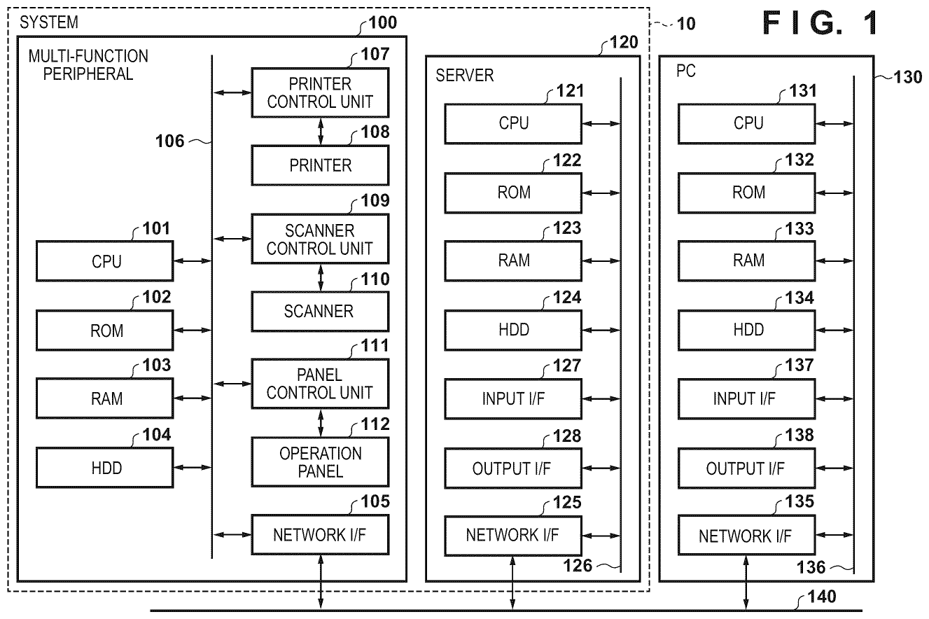

A hardware configuration example of a multi-function peripheral 100, a server 120, and a personal computer (PC) 130 according to the first embodiment will be described with reference to FIG. 1. In the first embodiment, the multi-function peripheral 100 and the server 120 constitute a system 10. The system 10 is a system for providing the PC 130 with services provided by the multi-function peripheral 100. In the example of FIG. 1, the PC 130 is not included in the system 10. Alternatively, the PC 130 may be included in the system 10. In the example of FIG. 1, the system 10 includes one multi-function peripheral 100 and one server 120. Alternatively, the system 10 may include a plurality of multi-function peripherals 100 and one server 120. One multi-function peripheral 100 may be included in only one system 10 or may be included in two or more systems 10. In the example of FIG. 1, one PC 130 is illustrated. The system 10 may be used by a plurality of the PCs 130.

The multi-function peripheral 100 is a device having at least two of a scan function, a print function, and a copy function. In place of the multi-function peripheral 100, any device (e.g., a dedicated printing machine, a sensor, a home appliance, or the like) that can provide services to an external apparatus (e.g., the PC 130) may be used in the system 10. In this manner, the device that can provide services to external apparatuses may be called a device having a server function. The following example assumes a web server function as an example of a server function of the multi-function peripheral 100. Alternatively or additionally, the multi-function peripheral 100 may have other server functions (e.g., a file transfer server function, an authentication server function, and the like).

The multi-function peripheral 100 may have the hardware components illustrated in FIG. 1. The multi-function peripheral 100 needs not include some components of the components illustrated in FIG. 1, or may include components not illustrated in FIG. 1. The same applies to the components of the server 120 and the PC 130.

A central processing unit (CPU) 101 is a processor for controlling the overall operation of the multi-function peripheral 100. A read only memory (ROM) 102 is a read-only nonvolatile memory. The ROM 102 may store a boot program. The boot program is read and executed by the CPU 101 in response to the power of the multi-function peripheral 100 being turned on. A random access memory (RAM) 103 is a readable/writable volatile memory. The RAM 103 temporarily stores programs, data, and the like for the CPU 101 to control the multi-function peripheral 100.

A hard disk drive (HDD) 104 is a storage device that semi-permanently stores programs, data, and the like for the CPU 101 to control the multi-function peripheral 100. In place of or in addition to the HDD, another storage device such as a solid state drive (SSD) may be used. The programs and data stored in the HDD 104 may be read into the RAM 103 by the CPU 101.

A network interface (I/F) 105 is a device for communicating with external apparatuses. Communication with the external apparatuses may be wired or wireless. The network I/F 105 that performs wired communication may include a connector for connecting a cable and a signal processing circuit for processing data to be transmitted and received. The network I/F 105 that performs wireless communication may include an antenna for transmitting and receiving data and a signal processing circuit for processing the transmitted and received data.

A printer control unit 107 controls the operation (e.g., printing) of a printer 108. A scanner control unit 109 controls the operation (e.g., reading of documents) of a scanner 110. A panel control unit 111 controls the operation of an operation panel 112. The operation panel 112 is a touch panel type operation unit. The operation panel 112 may include a display for displaying information for a user of the multi-function peripheral 100 and a touch sensor for acquiring instruction input from the user of the multi-function peripheral 100.

The above-described components of the multi-function peripheral 100 are connected to one another by a bus 106. Control signals from the CPU 101 and data signals between the components are transmitted and received through the bus 106.

The server 120 is an information processing apparatus for relaying, to the PC 130, services provided by the multi-function peripheral 100. Components 121 to 126 of the server 120 may be similar to the components 101 to 105 of the multi-function peripheral 100, and therefore redundant description will be omitted. An input I/F 127 is a device for connecting an input device (e.g., a mouse or a keyboard) for acquiring instruction input from the user of the server 120. An output I/F 128 is a device for connecting an output device (e.g., a display or a speaker) for outputting information for the user of the server 120.

The PC 130 is an information processing apparatus for using services provided by the system 10. In place of the PC 130, another information processing apparatus (e.g., a smartphone or a tablet) may be used. Since component 131 to 138 of the server 120 may be similar to the component 101 to 105 of the multi-function peripheral 100 and the component 127 and 128 of the server 120, redundant description will be omitted. An input device connected to the input I/F 137 and an output device connected to the output I/F 138 may be built in the PC 130.

The multi-function peripheral 100, the server 120, and the PC 130 are connected to a network 140. The multi-function peripheral 100 and the server 120 can communicate with each other through the network 140. The server 120 and the PC 130 can communicate with each other through the network 140. The multi-function peripheral 100 and the PC 130 may be or needs not be able to communicate directly. The network 140 may be a private network such as a local area network, or may be a public network such as the Internet.

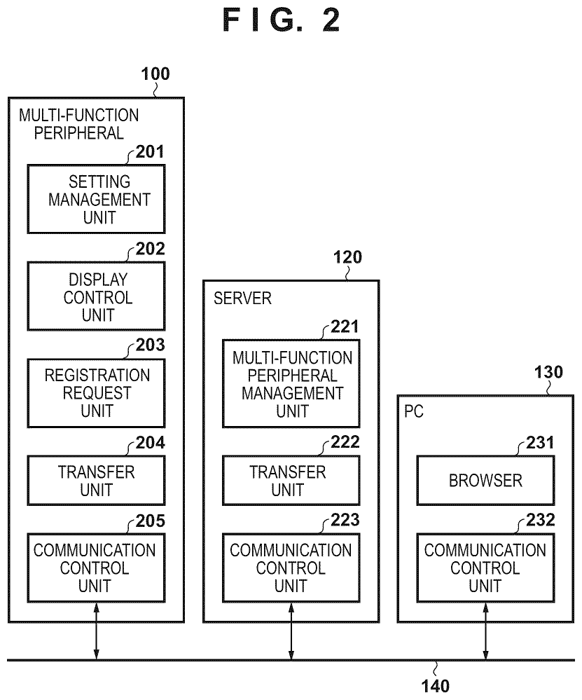

A software configuration example of the multi-function peripheral 100, the server 120, and the PC 130 will be described with reference to FIG. 2. The multi-function peripheral 100 may have the software components illustrated in FIG. 2. The multi-function peripheral 100 needs not include some components of the components illustrated in FIG. 2, or may include components not illustrated in FIG. 2. The software components of the multi-function peripheral 100 may be implemented by the CPU 101 reading them from the ROM 102 or the HDD 104 into the RAM 103 and executing the software components. Alternatively, at least some of the software components of the multi-function peripheral 100 may be implemented by a dedicated integrated circuit such as an application specific integrated circuit (ASIC). The same applies to the components of the server 120 and the PC 130.

First, a software configuration of the multi-function peripheral 100 will be described. A setting management unit 201 manages the setting of the multi-function peripheral 100. For example, the setting of the multi-function peripheral 100 may be stored in the HDD 104. In response to a request from the user, an external apparatus, or another component of the multi-function peripheral 100, the setting management unit 201 may store a new setting in the HDD 104 or update or delete a setting stored in the HDD 104. In response to a request from the user, an external apparatus, or another component of the multi-function peripheral 100, the setting management unit 201 may respond to the setting stored in the HDD 104.

The setting management unit 201 may acquire a request related to the setting of the multi-function peripheral 100 from the user through the operation panel 112, or may display the setting of the multi-function peripheral 100 on the operation panel 112. In addition to this, the setting management unit 201 may have a web server function. Using the web server function, the setting management unit 201 may acquire a request related to the setting of the multi-function peripheral 100 from an external apparatus (e.g., the PC 130) via the network I/F 105, or may respond the setting of the multi-function peripheral 100 to an external apparatus. As described above, the setting management unit 201 may be an application having the web server function. For example, the setting management unit 201 may receive a connection request by Hyper Text Transfer Protocol (HTTP) from an external apparatus at a port No. 80. In place of or in addition to this, the setting management unit 201 may receive a connection request by HTTP Secure (HTTPS) from an external apparatus through a port 443. The setting management unit 201 may transmit and receive data (e.g., a request or a response) used for processing related to the setting of the multi-function peripheral 100 through the connection established by these protocols.

The web server function of the setting management unit 201 is settable to be enabled or disabled. When the web server function is enabled, the setting management unit 201 accepts a request from an external apparatus via the network 140. When the web server function is disabled, the setting management unit 201 rejects a request from an external apparatus via the network 140. For example, the setting management unit 201 may discard a packet transmitted to a port (e.g., the port No. 80 or the port No. 443) for providing the web server function.

A display control unit 202 displays information on the operation panel 112. For example, the display control unit 202 may generate a screen to be displayed on the operation panel 112. A registration request unit 203 requests the server 120 for registration of the multi-function peripheral 100. This request may include identification information and authentication information on the multi-function peripheral 100. A transfer unit 204 transfers data between the server functions (e.g., the web server function of the setting management unit 201) of the multi-function peripheral 100 and the server 120.

A communication control unit 205 is connected to the network 140 using the network I/F 105, and communicates with other apparatuses (e.g., the server 120) through the network 140. Communication between the above-described components of the multi-function peripheral 100 and the other apparatuses is performed through the communication control unit 205.

Next, a software configuration of the server 120 will be described. A multi-function peripheral management unit 221 manages the multi-function peripheral 100 included in the system 10. For example, in response to reception of a registration request from the multi-function peripheral 100, the multi-function peripheral management unit 221 manages this multi-function peripheral 100 by storing identification information on the multi-function peripheral 100 into the HDD 124. The information on the multi-function peripheral 100 managed by the multi-function peripheral management unit 221 may be acquired from the user of the server 120 through the input I/F 127 of the server 120.

A transfer unit 222 transfers data between the multi-function peripheral 100 and the PC 130. A communication control unit 223 may be similar to the communication control unit 205, and therefore redundant description will be omitted.

Next, a software configuration of the PC 130 will be described. A browser 231 is client software that uses services provided by a web server (e.g., the web server function of the multi-function peripheral 100). The browser 231 displays, onto a display of the PC 130, a screen generated based on the data received from the web server. The browser 231 transmits, to the web server, the user input performed on this screen. A communication control unit 232 may be similar to the communication control unit 205, and therefore redundant description will be omitted.

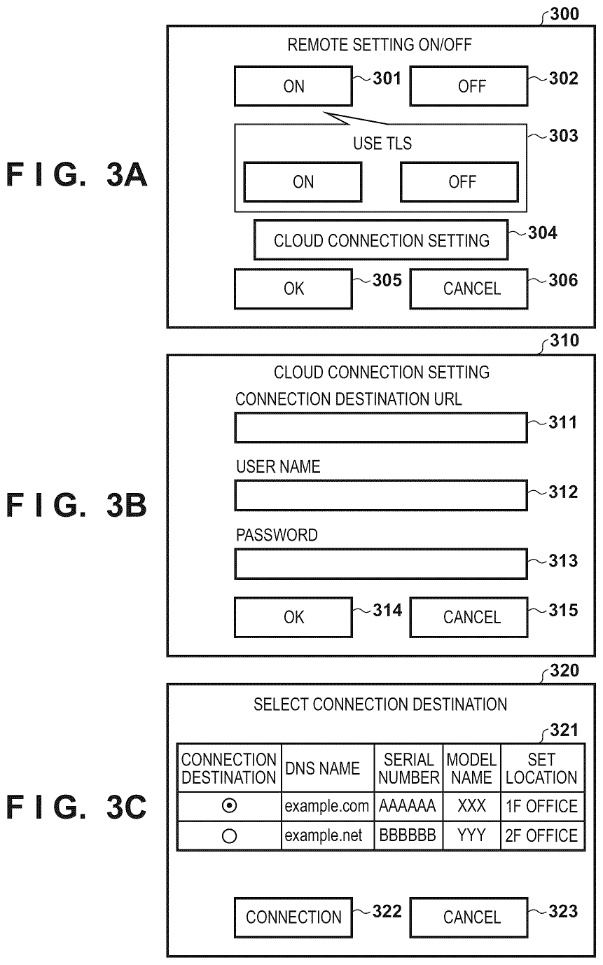

An example of the screen generated by the system 10 will be described with reference to FIGS. 3A to 3C. First, a screen 300 of FIG. 3A will be described, and the screens of FIGS. 3B and 3C will be described later.

The screen 300 is a screen for acquiring the setting related to a remote setting function from the user. The remote setting function may be a web server function for setting the multi-function peripheral 100 from an external apparatus (e.g., the PC 130) through the network 140. When the remote setting function is enabled, the user can check and change the setting of the multi-function peripheral 100 from the external apparatus through the network 140. When the remote setting function is disabled, the user cannot check and change the setting of the multi-function peripheral 100 from the external apparatus through the network 140. Even in this case, the user can confirm and change the settings of the multi-function peripheral 100 using the operation panel 112 of the multi-function peripheral 100.

The screen 300 may be displayed on the operation panel 112 of the multi-function peripheral 100 in response to a request from the user. The input to the screen 300 may be acquired by the operation panel 112 of the multi-function peripheral 100.

When the remote setting function of the setting management unit 201 is enabled, data for generating the screen 300 may be transmitted from the multi-function peripheral 100 to the PC 130 in response to a request from the browser 231 of the PC 130, and the screen 300 may be displayed on the display of the PC 130. The input to the screen 300 may be acquired by the input device of the PC 130 and transmitted to the multi-function peripheral 100.

When the remote setting function is enabled, data for generating the screen 300 may be transmitted from the multi-function peripheral 100 directly to the PC 130 (i.e., not via the server 120), or may be transmitted from the multi-function peripheral 100 to the PC 130 via the server 120.

A button 301 is a graphics object for acquiring a user instruction for enabling the remote setting function. In response to a button 305 being pressed in a state where the button 301 is selected, the setting management unit 201 enables the remote setting function. Specifically, the setting management unit 201 may open the port No. 80 and the port No. 443. A button 302 is a graphics object for acquiring a user instruction for disabling the remote setting function. In response to a button 305 being pressed in a state where the button 302 is selected, the setting management unit 201 disables the remote setting function. Specifically, the setting management unit 201 may close the port No. 80 and the port No. 443. When a button 306 is pressed, the setting management unit 201 does not reflect the setting for the screen 300.

When the button 301 is selected, the setting management unit 201 may further display a window 303. The window 303 is an object for setting whether to limit the protocols accepted by the remote setting function to HTTPS that uses Transport Layer Security (TLS). When the protocols are set to be limited to HTTPS, the setting management unit 201 may accept the request by HTTPS or reject the request by HTTP. Specifically, the setting management unit 201 may close the port No. 80 and open the port No. 443. When the protocols are set not to limited to HTTPS, the setting management unit 201 may accept a request by HTTP and a request by HTTPS. Specifically, the setting management unit 201 may open the port No. 80 and the port No. 443.

A button 304 is a graphics object for acquiring a user instruction to set cloud connection. In response to the button 304 being pressed, the setting management unit 201 displays a screen 310 of FIG. 3B. Details of the screen 310 will be described later.

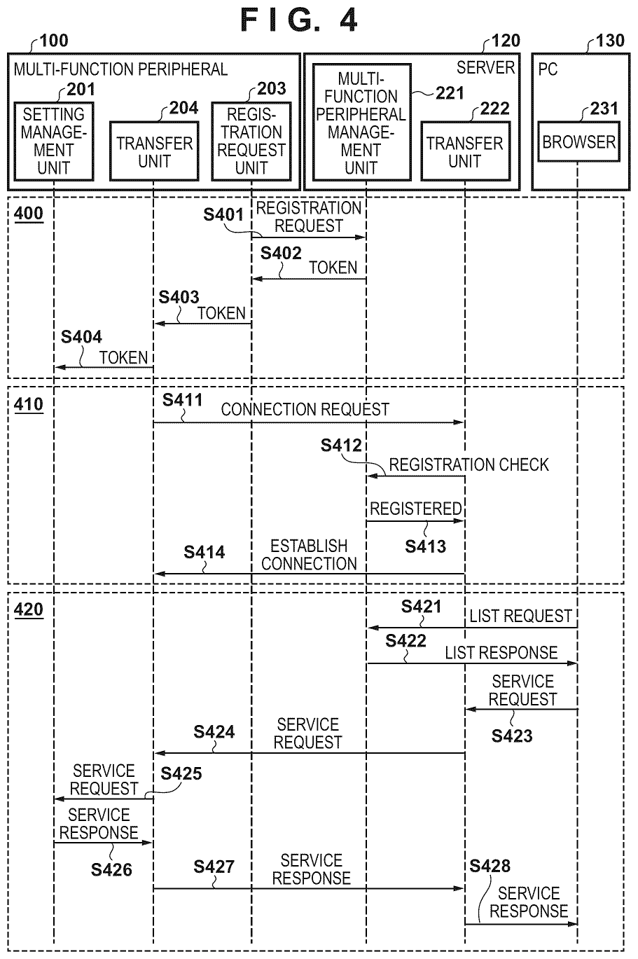

The overall operation of the system 10 will be described with reference to the sequence diagram of FIG. 4. In FIG. 4, a case where the web server function (e.g., the remote setting function) of the multi-function peripheral 100 (specifically, the setting management unit 201) is disabled will be described. For example, the administrator of the multi-function peripheral 100 may disable the web server function when the multi-function peripheral 100 is used in a LAN-less environment. The operation of FIG. 4 may also be executable when the web server function of the multi-function peripheral 100 is enabled.

The operation of the system 10 may include a registration operation 400, a connection operation 410, and a service provision operation 420. The registration operation 400 is an operation of registering the multi-function peripheral 100 into the server 120. The connection operation 410 is an operation of establishing a connection between the multi-function peripheral 100 and the server 120. The service provision operation 420 is an operation in which the system 10 provides the PC 130 with services provided by the web server function of the multi-function peripheral 100. Because the connection operation 410 is performed as a preparation for executing the service provision operation 420, it may be called a preparation operation. The request from the PC 130 is transferred from the server 120 to the multi-function peripheral 100 in the service provision operation 420, the service provision operation 420 may be called a transfer operation.

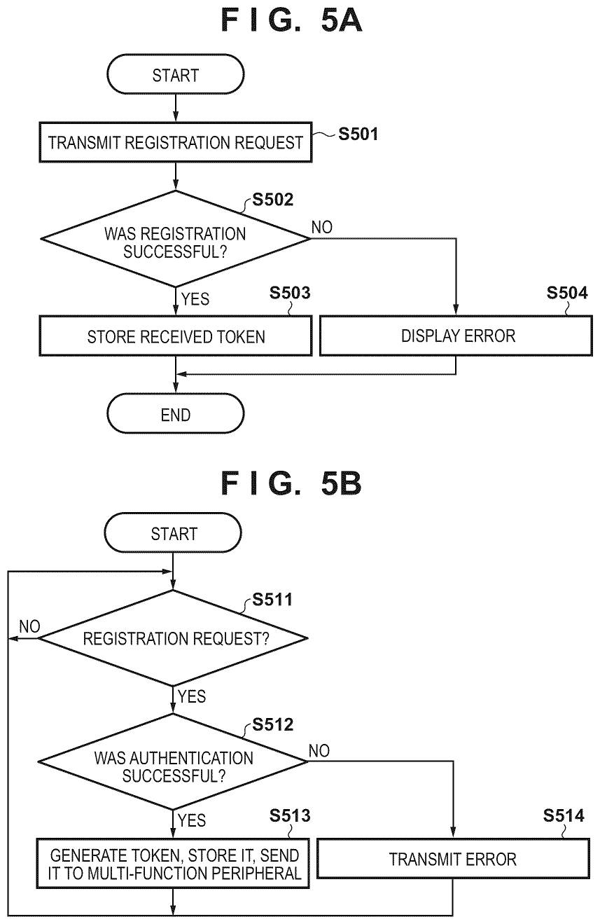

First, the registration operation 400 will be described with reference to FIGS. 4 to 5B. FIG. 5A describes a method executed by the multi-function peripheral 100 in the registration operation 400. The multi-function peripheral 100 may start the operation of FIG. 5A in response to an instruction from the user of the multi-function peripheral 100 (e.g., in response to the button 314 being pressed). FIG. 5B describes a method executed by the server 120 in the registration operation 400. The server 120 may repeatedly execute the operation of FIG. 5B during operation. Although FIG. 5B shows the operation of the server 120 with respect to the multi-function peripheral 100, the server 120 may execute a similar operation for another multi-function peripheral or another device.

In S501, the registration request unit 203 of the multi-function peripheral 100 transmits, to the server 120, a request for registering the multi-function peripheral 100 into the server 120 (corresponding to S401 in FIG. 4). In the following description, a request for registering the multi-function peripheral 100 into the server 120 is called a registration request.

The registration request may include identification information on the multi-function peripheral 100. As described later, the identification information on the multi-function peripheral 100 is used by the user who uses the web server function of the multi-function peripheral 100 in order to identify the multi-function peripheral 100 in the service provision operation 420. The identification information on the multi-function peripheral 100 may be any information for the user to identify the multi-function peripheral 100. For example, the identification information on the multi-function peripheral 100 may be a combination of a domain name system (DNS) name of the domain to which the multi-function peripheral 100 belongs, a serial number of the multi-function peripheral 100, a model name of the multi-function peripheral 100, and an installation location of the multi-function peripheral 100. Alternatively or additionally, the identification information on the multi-function peripheral 100 may include at least one of an Internet protocol (IP) address of the multi-function peripheral 100, a media access control (MAC) address of the multi-function peripheral 100, and an apparatus name of the multi-function peripheral 100 set by the user. The identification information on the multi-function peripheral 100 may be set by the user before the method of FIG. 5A is executed, or may be set at the time of manufacturing of the multi-function peripheral 100 and stored in the HDD 104.

When the server 120 requires user authentication for registering the multi-function peripheral 100, the registration request may include a user credential instructing the multi-function peripheral 100 for transmission of the registration request. The credential may be, for example, a combination of a user name and a password. Alternatively, the credential may be other information that enables the user to be authenticated as authorized, for example, a client certificate. The user credential may be used as user identification information for identifying the user.

The screen 310 used for acquiring an instruction for transmission of the registration request from the user will be described with reference to FIG. 3B. As described above, the screen 310 may be displayed on the operation panel 112 of the multi-function peripheral 100 in response to the button 304 on the screen 300 being pressed.

A field 311 is a graphics object for inputting a uniform resource locator (URL) of the server 120. A field 312 is a graphics object for inputting the user name. A field 313 is a graphics object for inputting the password. In response to the button 305 being pressed in a state where the fields 311 to 313 are input, the setting management unit 201 generates a registration request including the information input to the fields 312 and 313 and the identification information on the multi-function peripheral 100, and transmits this registration request to the URL input to the field 311. When a button 315 is pressed, the setting management unit 201 does not transmit the registration request. When the server 120 does not require user authentication for registering the multi-function peripheral 100, the screen 310 needs not include the fields 312 and 313, and the registration request needs not include the user credential. The information input in the fields 311 to 313 may be stored in the HDD 104 for subsequent processing.

In S511, the multi-function peripheral management unit 221 of the server 120 determines whether a registration request has been received from the multi-function peripheral 100. When determining that the registration request has been received from the multi-function peripheral 100 (“YES” in S511), the multi-function peripheral management unit 221 shifts the process to S512, and otherwise (“NO” in S511), repeats S511.

In S512, the multi-function peripheral management unit 221 of the server 120 authenticates the user who has instructed the transmission of the registration request. For example, before the method of FIG. 5B is executed, a list of credentials of the user who can execute registration of the multi-function peripheral 100 may be stored in the HDD 124 of the server 120. The multi-function peripheral management unit 221 may determine that the authentication is successful when the list of the credentials stored in the HDD 124 includes the credential included in the registration request. On the other hand, the multi-function peripheral management unit 221 may determine that the authentication has failed when the list of the credentials stored in the HDD 124 does not include the credential included in the registration request.

When determining that the user authentication is successful (“YES” in S512), the multi-function peripheral management unit 221 shifts the process to S513, and otherwise (“NO” in S512), shifts the process to S514. When the server 120 does not require user authentication for registering the multi-function peripheral 100, S512 may be omitted, and S513 may be executed after S511.

In S513, the multi-function peripheral management unit 221 of the server 120 registers the multi-function peripheral 100. Specifically, the multi-function peripheral management unit 221 generates an access token for the multi-function peripheral 100, and stores this access token into the HDD 124 in association with the identification information on the multi-function peripheral 100 included in the registration request. The multi-function peripheral in which the identification information and the access token are stored in association with each other is the multi-function peripheral registered in the server 120. When canceling the registration of the multi-function peripheral, the multi-function peripheral management unit 221 may delete this information from the HDD 124. Furthermore, the multi-function peripheral management unit 221 may register, in association with the multi-function peripheral 100, the user identification information related to the registration request. The user identification information related to the registration request may be the user credential received in S512, or may be other information.

The multi-function peripheral management unit 221 transmits the generated access token to the multi-function peripheral 100 (corresponding to S402 in FIG. 4). In S514, the multi-function peripheral management unit 221 of the server 120 transmits an error notification to the multi-function peripheral 100. The error notification may indicate that the user authentication has failed. After S513 or S514, the multi-function peripheral management unit 221 of the server 120 waits for a registration request from the multi-function peripheral 100 or another device in S511.

In S502, the registration request unit 203 of the multi-function peripheral 100 determines whether registration of the multi-function peripheral 100 is successful. When determining that the registration of the multi-function peripheral 100 is successful (“YES” in S502), the registration request unit 203 shifts the process to S503, and otherwise (“NO” in S502), shifts the process to S504. Based on reception of the access token from the server 120, the registration request unit 203 may determine that the registration of the multi-function peripheral 100 is successful. Based on reception of the error notification from the server 120, the registration request unit 203 may determine that the registration of the multi-function peripheral 100 has failed.

In S503, the multi-function peripheral 100 stores the access token received from the server 120 into the HDD 104. Specifically, the registration request unit 203 passes, to the transfer unit 204, the access token received from the server 120, and instructs the transfer unit 204 to store the access token in the RAM 103 (corresponding to S403 in FIG. 4). In response to this instruction, the transfer unit 204 stores the access token into the RAM 103. Thereafter, the transfer unit 204 instructs the setting management unit 201 to store, into the HDD 104, the access token stored in the RAM 103 (corresponding to S404 in FIG. 4). In response to this instruction, the transfer unit 204 stores the access token into the HDD 104.

In S504, the registration request unit 203 of the multi-function peripheral 100 may display, on the operation panel 112, an error message indicating that the registration of the multi-function peripheral 100 has failed.

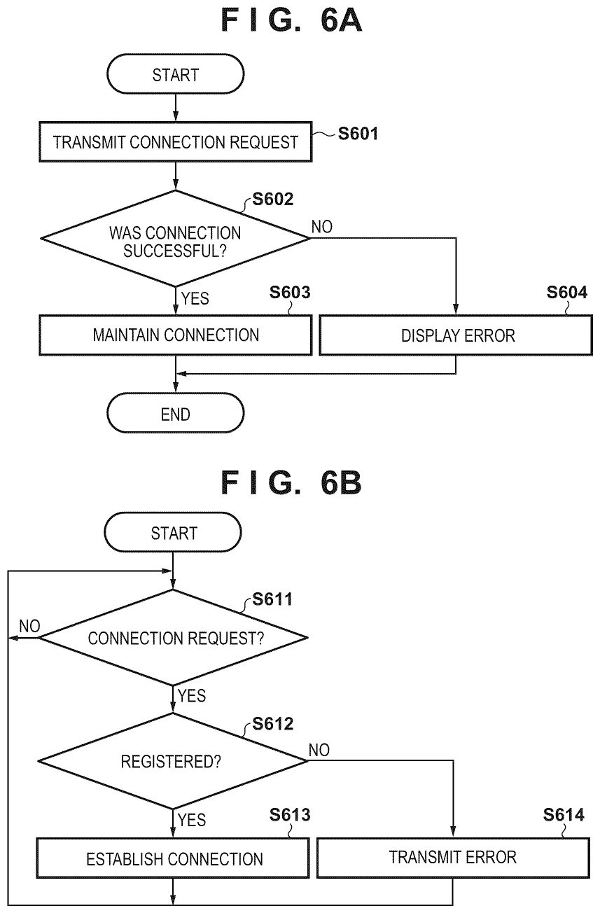

Next, the connection operation 410 will be described with reference to FIGS. 4, 6A, and 6B. FIG. 6A describes a method executed by the multi-function peripheral 100 in the connection operation 410. The multi-function peripheral 100 may start the operation of FIG. 6A in response to completion of S503, in response to the power of the multi-function peripheral 100 being turned on, or in response to an instruction from the user. FIG. 6B describes a method executed by the server 120 in the connection operation 410. The server 120 may repeatedly execute the operation of FIG. 6B during operation. Although FIG. 6B shows the operation of the server 120 with respect to the multi-function peripheral 100, the server 120 may execute a similar operation for another multi-function peripheral or another device.

In S601, the transfer unit 204 of the multi-function peripheral 100 transmits, to the server 120, a request for establishing a connection between the multi-function peripheral 100 and the server 120 (corresponding to S411 in FIG. 4). In the following description, a request for establishing a connection between the multi-function peripheral 100 and the server 120 is called a connection request. This connection may include transmission control protocol (TCP) connection.

The connection request may include identification information on the multi-function peripheral 100 and an access token. The identification information on the multi-function peripheral 100 may be the same as the identification information included in the registration request transmitted in S501. The access token may be the access token received in S502 and stored in the HDD 104.

The connection established between the server 120 and the multi-function peripheral 100 is maintained semi-permanently. For example, this connection is maintained unless the multi-function peripheral 100 or the server 120 is powered off or explicitly disconnected from the user of the system 10. Therefore, in the following description, this connection is called a constant connection.

The connection request may explicitly or implicitly include an indication indicating that the server 120 is prohibited from disconnecting the connection between the multi-function peripheral 100 and the server 120. For example, this indication may be that the connection request includes the identification information on the multi-function peripheral 100 and the access token. Alternatively, the connection request may include a flag indicating that the server 120 is prohibited from disconnecting the connection between the multi-function peripheral 100 and the server 120.

In S611, the transfer unit 222 of the server 120 determines whether a connection request has been received from the multi-function peripheral 100. When determining that the connection request has been received from the multi-function peripheral 100 (“YES” in S611), the transfer unit 222 shifts the process to S612, and otherwise, repeats S611 (“NO” in S611).

In S612, the transfer unit 222 of the server 120 determines whether the multi-function peripheral 100 that has transmitted the connection request is registered in the server 120. When determining that the multi-function peripheral 100 that has transmitted the connection request is registered in the server 120 (“YES” in S612), the transfer unit 222 shifts the process to S613, and otherwise (“NO” in S612), shifts the process to S614. Specifically, the transfer unit 222 may inquire of the multi-function peripheral management unit 221 whether the multi-function peripheral 100 that has transmitted the connection request is registered in the server 120 (corresponding to S412 in FIG. 4). When a combination of the identification information and the access token included in the connection request is stored in the HDD 104, the multi-function peripheral management unit 221 may determine that the multi-function peripheral 100 that has transmitted the connection request is registered in the server 120. When the combination of the identification information and the access token included in the connection request is not stored in the HDD 104, the multi-function peripheral management unit 221 may determine that the multi-function peripheral 100 that has transmitted the connection request is not registered in the server 120. As described above, the identification information on the multi-function peripheral registered in the server 120 and the access token associated therewith are stored in the HDD 104. The multi-function peripheral management unit 221 returns a determination result to the transfer unit 222 (corresponding to S413 in FIG. 4). In the above example, whether the multi-function peripheral 100 is registered in the server 120 is determined based on the combination of the identification information and the access token. Alternatively, whether the multi-function peripheral 100 is registered in the server 120 may be determined based on only one of the identification information and the access token.

In S613, the transfer unit 222 of the server 120 establishes a constant connection between the multi-function peripheral 100 and the server 120 based on the multi-function peripheral 100 being registered in the server 120 (corresponding to S414 in FIG. 4). The server 120 maintains this constant connection. In S614, the transfer unit 222 of the server 120 transmits an error notification to the multi-function peripheral 100. The error notification may indicate that the multi-function peripheral 100 is not registered in the server 120. After S613 or S614, the transfer unit 222 of the server 120 waits for a connection request from the multi-function peripheral 100 or another device in S611.

In S602, the transfer unit 204 of the multi-function peripheral 100 determines whether establishment of the constant connection is successful. When determining that the establishment of the constant connection is successful (“YES” in S602), the transfer unit 204 shifts the process to S603, and otherwise (“NO” in S602), shifts the process to S604. Based on notification of connection completion from the server 120, the transfer unit 204 may determine that the establishment of the constant connection is successful. Based on reception of the error notification from the server 120, the transfer unit 204 may determine that the establishment of the constant connection has failed.

In S603, the transfer unit 204 of the multi-function peripheral 100 maintains the constant connection. That is, the multi-function peripheral 100 does not disconnect the constant connection during operation. In S604, the transfer unit 204 of the multi-function peripheral 100 may display, on the operation panel 112, an error message indicating that the establishment of the constant connection has failed. When the method of FIG. 6A is started not by an instruction from the user, the transfer unit 204 may record an error message into a log in place of displaying the error message on the operation panel 112.

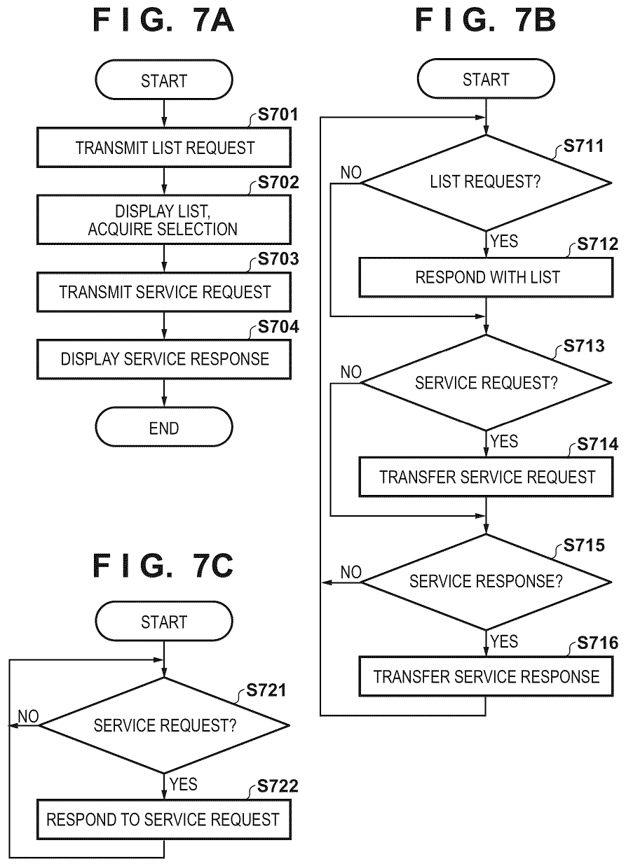

Next, the service provision operation 420 will be described with reference to FIGS. 4 and 7A to 7C. FIG. 7A describes a method executed by the PC 130 in the service provision operation 420. The PC 130 may start the operation of FIG. 7A in response to acquisition, from the user of the PC 130, of an instruction for displaying a list of multi-function peripherals registered in the server 120. FIG. 7B describes a method executed by the server 120 in service provision operation 420. The server 120 may repeatedly execute the operation of FIG. 7B during operation. Although FIG. 7B shows the operation of the server 120 with respect to the multi-function peripheral 100, the server 120 may execute a similar operation for another multi-function peripheral or another device. FIG. 7C describes a method executed by the multi-function peripheral 100 in the service provision operation 420. The multi-function peripheral 100 may repeatedly execute the operation of FIG. 7C after the constant connection is established.

In S701, the browser 231 of the PC 130 transmits, to the server 120, a request for the list of multi-function peripherals registered in the server 120 (corresponding to S421 in FIG. 4). In the following description, this request is called a list request. The URL of the server 120 may be entered by the user. As described below, the PC 130 is connected via the server 120 to a multi-function peripheral registered in the server 120, and can use the web server function of this multi-function peripheral. When user authentication is required for requesting the list of multi-function peripherals registered with the server 120, the list request may include the user credential.

In step S711, the multi-function peripheral management unit 221 of the server 120 determines whether a list request has been received from the PC 130. When determining that the list request has been received from the PC 130 (“YES” in S711), the multi-function peripheral management unit 221 shifts the process to S712, and otherwise (“NO” in S711), shifts the process to S713.

In S712, the multi-function peripheral management unit 221 of the server 120 responds to the PC 130 with the list of multi-function peripheral registered in the server 120 (corresponding to S422 in FIG. 4). For example, the server 120 responds to the PC 130 with data for displaying a screen including the list of multi-function peripherals. Information regarding the multi-function peripherals registered in the server 120 is stored in the HDD 124. The multi-function peripheral management unit 221 may include, into the response, identification information (i.e., the identification information included in the registration request acquired in S511) of the multi-function peripherals stored in the HDD 124. When user authentication is required for responding with the list, the multi-function peripheral management unit 221 may perform user authentication and respond to the list only when the authentication is successful. The user authentication may be performed in the same manner as in S512, or may be performed by another method.

The multi-function peripheral management unit 221 may respond to the PC 130 with a list of all the multi-function peripherals registered in the server 120. Alternatively, the multi-function peripheral management unit 221 may respond with a list of, among the multi-function peripherals registered in the server 120, multi-function peripheral registered in association with the user identification information acquired in relation to the list request. In this case, the user of the PC 130 can acquire information on only the multi-function peripheral registered by the user. What list the server 120 to respond with may be set in advance and stored in the HDD 124.

In step S702, the browser 231 of the PC 130 displays, onto the display of the PC 130, a screen including the list received from the server 120. An example of such a screen 320 will be illustrated with reference to FIG. 3C. A graphics object 321 is a list of multi-function peripherals (i.e., the multi-function peripherals registered in the server 120) responded from the server 120.

Processing when a button 332 is pressed in a state where any one of the multi-function peripherals is selected with a radio button of the graphics object 321 will be described. In the following description, it is assumed that the multi-function peripheral 100 is selected. In S703, the browser 231 of the PC 130 transmits, to the server 120, a request for connecting to the web server function (e.g., the remote setting function) of the multi-function peripheral 100 (corresponding to S423 in FIG. 4). In the following description, such a request is called a service request. The service request may be a request by HTTPS. When a button 323 is pressed, the browser 231 does not transmit the service request.

In step S713, the transfer unit 222 of the server 120 determines whether a service request has been received from the PC 130. When determining that the service request has been received from the PC 130 (“YES” in S713), the transfer unit 222 shifts the process to S714, and otherwise (“NO” in S713), shifts the process to S715. At the time of execution of S713, the constant connection is in a state of being established.

In S714, the transfer unit 222 of the server 120 transfers, to the multi-function peripheral 100 through the constant connection, the service request received from the PC 130 (corresponding to S424 in FIG. 4). Since the constant connection is established in response to the connection request from the multi-function peripheral 100, the server 120 can transmit the service request to the multi-function peripheral 100 even when the port of the web server function of the multi-function peripheral 100 is closed.

In S721, the transfer unit 204 of the multi-function peripheral 100 determines whether a service request has been received from the server 120 through the constant connection. When determining that the service request has been received from the server (“YES” in S721), the transfer unit 204 shifts the process to S722, and otherwise, repeats S721 (“NO” in S721).

In S722, the multi-function peripheral 100 transmits a service response to the server 120 in response to the service request. The service response may be a response by HTTPS. The multi-function peripheral 100 may transmit this service response through the constant connection.

Specifically, the transfer unit 204 of the multi-function peripheral 100 transmits the service request to the web server function of the setting management unit 201 by local loopback connection in the multi-function peripheral 100 (corresponding to S425 in FIG. 4). This connection request may be a request by HTTPS. The web server function of the setting management unit 201 generates and returns, to the transfer unit 204, a connection response to the connection request (corresponding to S426 in FIG. 4). The transfer unit 204 transfers this connection response to the server 120 as a service response (corresponding to S427 in FIG. 4).

In S715, the transfer unit 222 of the server 120 determines whether a service response has been received from the multi-function peripheral 100 through the constant connection. When determining that the service response has been received from the multi-function peripheral 100 (“YES” in S715), the transfer unit 222 shifts the process to S716, and otherwise (“NO” in S715), shifts the process to S711.

In S716, the transfer unit 222 of the server 120 transfers, to the PC 130, the service response received from the multi-function peripheral 100 (corresponding to S428 in FIG. 4). In step S704, the browser 231 of the PC 130 displays, on the display of the PC 130, a screen (e.g., a screen provided by the web server function of the setting management unit 201) generated based on the service response received from the server 120.

According to the above-described method, even when the port of the web server function of the multi-function peripheral 100 is closed, the web server function of the multi-function peripheral 100 can return a response to the request via the server 120. Therefore, even when the multi-function peripheral 100 is disposed in a LAN-less environment, the web server function of the multi-function peripheral 100 can be provided to the PC 130 with the port remaining closed (i.e., while security remaining improved). For example, even when the PC 130 is connected to a network different from that of the multi-function peripheral 100, if the PC 130 can access the server 120, the PC 130 can use the web server function of the multi-function peripheral 100, and convenience is improved.

Since the server 120 receives the service request from the PC 130 in the state where the constant connection is established, the service request can be quickly transferred to the multi-function peripheral 100. Furthermore, since the web server function of (e.g., the setting management unit 201) of the multi-function peripheral 100 can be used as it is, a process of providing the web server function by a client operation is no longer necessary, and it is possible to suppress an extra maintenance cost for a developer.

In the above-described embodiment, the multi-function peripheral 100 provides the web server function, and the PC 130 performs HTTPS communication with the multi-function peripheral 100 via the server 120. Alternatively, the multi-function peripheral 100 may provide a server function in accordance with another protocol, and the PC 130 may use the server function of the multi-function peripheral 100 with another protocol via the server 120. For example, a network apparatus management client operating on the PC 130 may acquire information from the multi-function peripheral 100 via the server 120 by a simple network management protocol (SNMP).

In the above-described method, S421 and S422 in FIGS. 4, S701 and S702 in FIG. 7A, and S711 and S712 in FIG. 7B may be omitted. In this case, in S703, the PC 130 may designate the multi-function peripheral to be connected and transmit a service request to the server 120. Such a form is useful for protocols or applications that do not display a screen.

### Second Embodiment

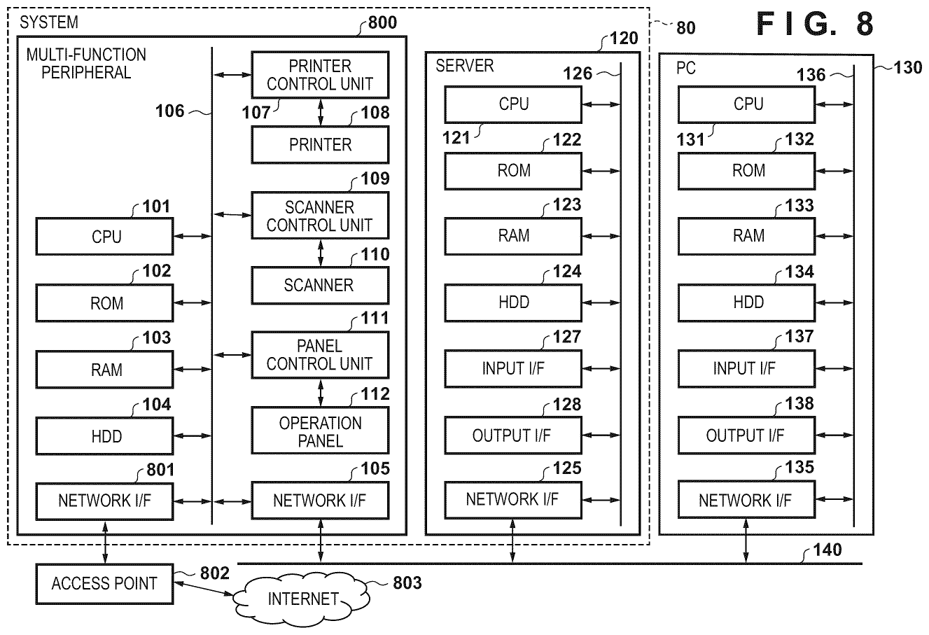

A system 80 according to the second embodiment will be described with reference to FIG. 8. In the following description regarding the second embodiment, differences from the first embodiment will be mainly described, and description of points that may be similar to the first embodiment will be omitted.

The system 80 is different from the system 10 in including a multi-function peripheral 800 in place of the multi-function peripheral 100. Similarly to the first embodiment, the system 80 may include a plurality of multi-function peripherals or other devices, and among others, may include both the multi-function peripheral 100 and the multi-function peripheral 800.

The multi-function peripheral 800 is different from the multi-function peripheral 100 in including a plurality of network I/Fs. In the example of FIG. 8, the multi-function peripheral 800 includes two network I/Fs, i.e., the network I/F 105 and a network I/F 801. Therefore, the multi-function peripheral 800 can be connected to different networks. For example, the network I/F 105 may be connected to the network 140. The network 140 may be a LAN installed in an on-premises environment. The network I/F 801 may be connected to an Internet 803 via an access point 802. Thus, the multi-function peripheral 800 can be connected to both the on-premises environment and the LAN-less environment.

The network I/F 801 may communicate with the access point 802 in a wired manner or in a wireless manner. The network I/F 105 may be treated as a main network I/F, and the network I/F 801 may be treated as a sub-network I/F. Alternatively, the network I/F 105 may be treated as a sub-network I/F, and the network I/F 801 may be treated as a main network I/F.

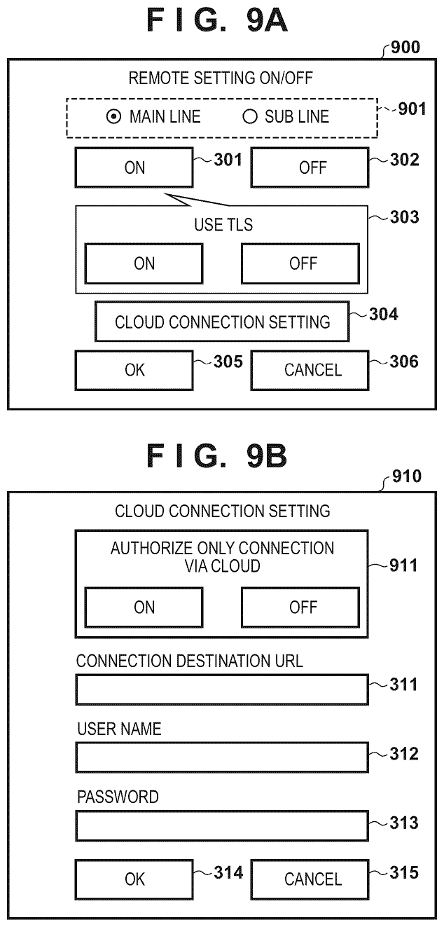

An example of a screen generated by the system 80 will be described with reference to FIGS. 9A and 9B. A screen 900 of FIG. 9A is a screen for acquiring the setting related to a remote setting function from the user. The screen 900 is different from the screen 300 in further including a radio button 901, and other points may be similar. The radio button 901 is a graphics object for acquiring, from the user, a designation as to which of the network I/F 105 and the network I/F 801 the target of setting of the remote setting function is. Using the screen 900, the setting management unit 201 of the multi-function peripheral 800 acquires, from the user, the setting related to the remote setting function for each of the two networks, I/Fs 105 and 801. Specifically, when “main line” is selected with the radio button 901, the setting management unit 201 acquires the setting for the network I/F 105. When “sub line” is selected with the radio button 901, the setting management unit 201 acquires the setting for the network I/F 801.

A screen 910 of FIG. 9B is a screen used for acquiring, from the user, an instruction for transmission of a registration request. The screen 910 is different from the screen 310 in further including a graphics object 911, and other points may be similar.

The graphics object 911 is used for acquiring, from the user, setting as to whether to enable a web server function (e.g., the remote setting function) to a service request transmitted to the multi-function peripheral 800 not via the constant connection. When ON is selected with the graphics object 911, the setting management unit 201 disables the web server function to the service request transmitted to the multi-function peripheral 800 not via the constant connection. When OFF is selected with the graphics object 911, the setting management unit 201 enables the web server function to the service request transmitted to the multi-function peripheral 800 not via the constant connection.

The settings made on the screens 900 and 910 may be stored in the HDD 104 and used in subsequent processing. For example, in response to the power of the multi-function peripheral 800 being turned on, the setting management unit 201 may read the setting related to the remote setting function stored in the HDD 104 and set the server port in accordance with this setting. The graphics object 911 may be used in the first embodiment. That is, a multi-function peripheral including one network I/F 105 such as the multi-function peripheral 100 may be settable as to whether to enable the web server function to a service request transmitted to the multi-function peripheral 800 not via the constant connection.

Whether the service request to the web server function can be made by the above setting is summarized in Table 1 below.

TABLE 1

| | | PERMIT | | |
|---|---|---|---|---|
| REMOTE | CLOUD | ONLY | | |
| SETTING | CONNECTION | CONNECTION | REQUEST NOT | REQUEST |
| FUNCTION | SETTING | VIA CLOUD | VIA SERVER | VIA SERVER |
| OFF | N/A | N/A | IMPOSSIBLE | IMPOSSIBLE |
| ON | NO | N/A | POSSIBLE | IMPOSSIBLE |
| ON | YES | OFF | POSSIBLE | POSSIBLE |
| ON | YES | ON | IMPOSSIBLE | POSSIBLE |

When the remote setting function is set to be disabled, the setting management unit 201 disables the server port for receiving a remote request to the remote setting function. As described above, the remote setting function is set to be disabled by the button 302 on the screen 900. In this case, it is not possible to perform both a service request via the constant connection and a service request not via the constant connection.

When the remote setting function is set to be enabled, the setting management unit 201 enables the server port for receiving a remote request to the remote setting function. As described above, the remote setting function is set to be enabled by the button 301 on the screen 900. In this case, a service request not via the constant connection is possible. When the remote setting function is enabled and the server 120 is not registered on the screen 910, the constant connection is not established. Therefore, it is not possible to perform a service request via the constant connection.

When the remote setting function is enabled and the server 120 is registered on the screen 910, the constant connection is established. Therefore, a service request via the constant connection is possible.

When it is set on the screen 910 to disable the web server function to the service request transmitted to the multi-function peripheral 800 not via the constant connection, it is not possible to perform a service request not via the constant connection. When it is set on the screen 910 to enable the web server function to the service request transmitted to the multi-function peripheral 800 not via the constant connection, a service request not via the constant connection is possible.

For example, when it is desired to use the remote setting function with priority given to performance in an on-premises environment, the remote setting function may be set to be enabled for the network I/F 105, and the multi-function peripheral 800 needs not be registered in the server 120. This can restrict the PC 130 connected to the network 140 so as to make a service request not via the constant connection. On the other hand, the remote setting function may be set to be enabled for the network I/F 801 connected to the Internet 803, the multi-function peripheral 800 may be registered in the server 120, and a service request not via the constant connection may be set to be disabled. This improves security.

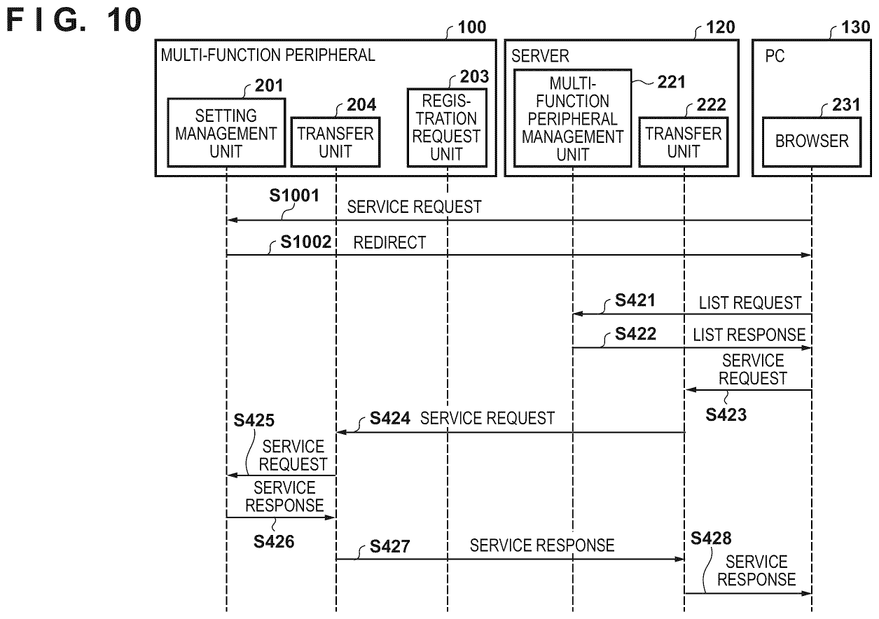

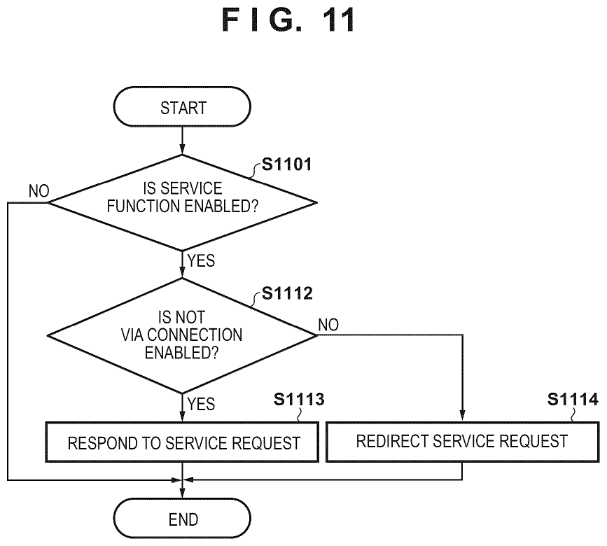

Subsequently, the operation of the system 80 will be described with reference to FIGS. 10 and 11. FIG. 10 illustrates a sequence diagram of the system 80. FIG. 11 describes a method executed by the multi-function peripheral 800. The multi-function peripheral 800 may execute the method of FIG. 11 in response to reception of a service request from the PC 130 not via the constant connection (corresponding to S1001 of FIG. 10).

In S1101, the setting management unit 201 of the multi-function peripheral 800 determines whether the remote setting function is enabled. When determining that the remote setting function is enabled (“YES” in S1101), the setting management unit 201 shifts the process to S1102, and otherwise, ends the processing (“NO” in S1101). When the remote setting function is disabled, the setting management unit 201 may discard the received remote request.

In S1102, the setting management unit 201 of the multi-function peripheral 800 determines whether the remote setting function is enabled to a service request not via the constant connection. When determining that the remote setting function is enabled to the service request not via the constant connection (“YES” in S1102), the setting management unit 201 shifts the process to S1103, and otherwise (“NO” in S1102), shifts the process to S1104.

In S1103, the setting management unit 201 of the multi-function peripheral 800 responds to the remote request. For example, the setting management unit 201 responds to the PC 130 with a screen for setting the multi-function peripheral 800.

In S1104, the setting management unit 201 of the multi-function peripheral 800 returns, to the PC 130, a response for redirecting the PC 130 to the server 120 (corresponding to S1002 in FIG. 10). For example, this response may include the URL of the server 120. Thereafter, the PC 130 may execute the processing in and after S701 of FIG. 7A. Alternatively, the PC 130 may execute the processing in and after S703 of FIG. 7A for the multi-function peripheral 800. By redirecting the PC 130 in this manner, the processing for executing the service request is continued.

In the above-described embodiment, whether to enable the remote setting function to a service request not via the constant connection is set in response to a user instruction. When any network I/F is set to connect to a LAN-less environment (i.e., when the remote setting function is set to be disabled to a service request transmitted to the multi-function peripheral 800 not via the constant connection), the setting management unit 201 of the multi-function peripheral 800 may automatically enable the remote setting function to the service request transmitted to the multi-function peripheral 800 via the constant connection for this network I/F. For example, when all the server ports (well known ports) of the multi-function peripheral 800 are set to be closed, the setting management unit 201 of the multi-function peripheral 800 may automatically enable the remote setting function to the service request transmitted to the multi-function peripheral 800 via the constant connection.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-004117, filed Jan. 15, 2024, which is hereby incorporated by reference herein in its entirety.

What is claimed is:

1. A system comprising a server and a device having a server function,
wherein the device is configured to
transmit, to the server, a connection request for establishing a connection between the device and the server,
receive a service request to the server function from the server through the connection,
acquire a response generated by the server function to the service request, and
transmit the response to the server, and
the server is configured to
establish the connection in response to the connection request from the device, and
transfer, to the device through the connection, the service request received from an information processing apparatus in a state in which the connection is established, and transfer, to the information processing apparatus, the response from the device to the service request.

2. The system according to claim 1, wherein the device is configured to transmit the service request received from the server to the server function by local loopback connection.

3. The system according to claim 1, wherein
the device is configured to transmit, to the server, a registration request asking for registering the device,
the server is configured to register the device that has transmitted the registration request, and
the server is configured to establish the connection based on the device being registered.

4. The system according to claim 3, wherein the server is configured to receive a list request asking for a list of registered devices from the information processing apparatus, and respond to the list request with the list of registered devices.

5. The system according to claim 4, wherein
the server is configured to
register, in association with the device, user identification information acquired in connection with the registration request, and
respond with the list of devices registered in association with user identification information acquired in connection with the list request.

6. The system according to claim 1, wherein the device is configured to acquire, from a user, a setting of whether to enable the server function to a service request transmitted to the device not via the connection.

7. The system according to claim 6, wherein
the device includes a plurality of network interfaces, and
the device is configured to acquire the setting from the user for each of the plurality of network interfaces.

8. The system according to claim 6, wherein the device is configured to redirect, to the server, the information processing apparatus that has transmitted the service request to the device not via the connection when the server function is set to be disabled to the service request transmitted to the device not via the connection.

9. The system according to claim 6, wherein the device is configured to automatically enable the server function to a service request transmitted to the device via the connection in response to the server function being set to be disabled to the service request transmitted to the device not via the connection.

10. The system according to claim 1, wherein the server is configured to transfer the service request to the device using HTTPS.

11. The system according to claim 1, wherein the device is a multi-function peripheral.

12. A method to be executed in a system including a server and a device having a server function, the method comprising:
transmitting, by the device, to the server, a connection request for establishing a connection between the device and the server;
establishing, by the server, the connection in response to the connection request from the device;
transferring, by the server, to the device through the connection, a service request to the server function of the device received from an information processing apparatus in a state in which the connection is established;
receiving, by the device, the service request through the connection;
acquiring, by the device, a response generated by the server function to the service request;
transmitting, by the device, the response to the server; and
transferring, by the server, to the information processing apparatus, the response from the device to the service request.

13. A device having a server function, wherein the device is configured to
transmit, to a server, a connection request for establishing a connection between the device and the server,
receive a service request to the server function from the server through the connection,
acquire a response generated by the server function to the service request, and
transmit the response to the server.

14. A non-transitory computer-readable storage medium storing a program for causing a computer to function as the device according to claim 13.

15. A server configured to
establish connection between a device having a server function and the server in response to a connection request from the device, and
transfer, to the device through the connection, a service request to the server function of the device received from an information processing apparatus in a state in which the connection is established, and transfer, to the information processing apparatus, a response from the device for the service request.

16. A non-transitory computer-readable storage medium storing a program for causing a computer to function as the server according to claim 15.
